(19) United States
(12) Patent Application Publication
(10) Pub. No.: US 2008/0297311 A1
(43) Pub. Date: Dec. 4, 2008

(54) NON-CONTACT SERVICE PROVIDING SYSTEMS

(76) Inventor: Xing-tao Wu, Woburn, MA (US)

Correspondence Address: XINGTAO WU, 229 WASHINGTON STREET, WOBURN, MA, 01001, US

(21) Appl. No.: 11/755,740

(22) Filed: May 31, 2007

(51) Int. Cl. H04B 10/00; G08B 13/14; H04Q 5/22

(52) U.S. Cl. 340/10.1; 235/375; 340/10.52; 340/572.1; 398/140

(57) ABSTRACT

A service providing system comprising a server device, a terminal device, and a service providing device in combination with an optical wireless tag device to achieve transmitting of ID, password, or other service information stored in the service providing device in a non-contact and non-broadcasting manner, thus enabling highly secured and reliable services.

### FIELD OF THE INVENTION

This invention relates to a non-contact service providing system comprising of a terminal, a server device, and a service providing device enclosed with an optical wireless ID tag, and. In particular, the invention relates to a technique of delivering a secured electronic transaction service or a secured and reliable identification service to a terminal from a service providing device by using an optical wireless ID tag.

### BACKGROUND OF THE INVENTION

Radio Frequency Identification (RFID) based wireless tag devices and services have been successfully used in various applications in various tag forms such as label, card, coin, and stick types. More recently, attentions have been paid to the electronic transaction functions by implementing RFID tag devices into portable hand held devices. In particular, one important class of such service providing devices—cell phones, is integrated with RFID tags to enable services such as credit card payments and ticketing pass card services.

However, using RFID based communication for wireless financial services could lead to fatal risks of card security and privacy because of the inherent broadcasting nature of the RF communication. For a credit card enabled cell phone device, failures of card security result in not only great direct financial loss but also customer dissatisfaction and possible nagging legal hassling. Though the security of the RFID communication can be improved with chip encryption, it remains technically breakable for professionals. A miniature RF recorder can be stealthily tapped in close proximity to a Point of Sale (POS) terminal to record thousands of cards and transaction data easily. The recorded data can be stored or relayed to a remote site where installed are equipments for breaking card encryption. The cost of equipments for breaking card encryption is marginal by comparison with the potential gains for professional identity theft providing enough incentive for organized professional crimes. Furthermore, being eavesdropped or tapped is not the only sensitive concern that may arise due to the uses of RFID based method for wireless financial services, signal cross talk and contamination between adjacent devices in a close proximity may disturb the operation reliability of the entire service providing platform.

Thus, there is a need for equipping a cell phone with a new wireless ID device capable of transmitting data in a non-broadcasting manner. There is a need for equipping a service providing device (e.g. a cell phone) with a new wireless ID device that offers immunizations not only from eavesdropping or tapping, from being relayed and/or amplified, but also from signal cross talk and contaminations. There is also a need for uses of such non-broadcasting identification devices with other service devices and apparatus systems to enable highly secured ID authentications.

### SUMMARY OF THE INVENTION

It is therefore an object of this invention to enhance card security of an service providing device (e.g. cell phone) by using a non-broadcasting optical wireless ID tag in replacement of an RFID tag.

It is a further object of this invention to provide a service providing device (e.g. a cell phone) with an integrated non-broadcasting wireless optical ID tag to enhance the data transmission reliability of a service providing system.

The service providing devices include cell phones, smart phones, media players, portable digital assistants (PDAs), digital cameras, game playing systems, view-finders, e-books, wristwatches, pagers, rings, necklaces, key chains, keys, and other portable hand held devices. The service providing devices may provide services including credit card/debit payment, road pass, ticketing, and other ID sensitive services. The service providing devices may also be used as switching devices to authorize the turning on and off conditions of ID sensitive equipments (e.g. an automobile), instruments, and apparatuses, thus minimizing the number of “keys” or identification “cards” one needs to maintain. Accordingly, the service providing device described herein provides a housing for the optical ID tag. Accordingly, the system for fulfilling the needs of various applications includes in general a terminal device for reading the tag, a server device, and a service providing device (e.g. cell phone) in integration with an optical ID tag device. Alternatively, the service providing system may not include a separate server device if the same functionalities in certain cases can be provided by either the terminal device or the service providing device.

In one aspect, such a terminal device includes a controller, a memory unit, a power source, and a mean for transmitting/receiving optical signals;

In another aspect, such a terminal device includes a controller, a memory unit, a power source, a light source, and a means for transmitting/receiving optical signals.

In one aspect, such an optical ID tag device includes a controller, a memory unit, a power source, a light modulator, and a mean for transmitting/receiving optical signals.

In another aspect, such an optical ID tag includes a controller, a memory unit, a power source, a light source, and a means for modulating and transmitting optical signals.

This invention results from the realization that an improved ID service device which eliminate the numerous problems with prior art RFID based service devices, including broadcasting communication, signal contamination, and being lack of security and privacy, is achieved by establishing a non-broadcasting optical wireless link by integrating the device with an optical ID tag.

In a preferred embodiment, the present invention provides a service providing device being integrated with a passive optical ID tag device wherein no light source is required, and wherein the optical ID tag device comprises of a Micro-Electro-Mechanical Systems (MEMS) light modulator attached to a corner cube retro-reflector, capable of modulating and retro-reflecting an interrogating incident light beam, thus enabling a non-broadcasting optical communication link while still maintaining insensitivity to incident angles.

In some embodiments, the MEMS light modulator is a rotational rigid micro-mirror installed onto one of the corner cube facets.

In some embodiments, the MEMS light modulator is an array of rotational rigid micro-mirrors installed onto one of the corner cube facets.

In some embodiments, the MEMS light modulator is a deformable membrane micro-mirror installed on one of the corner cube facets.

In some embodiments, the MEMS light modulator is an array of deformable membrane micro-mirrors installed on one of the corner cube facets.

In all embodiments, the corner cube retro-reflector can be either a hollow or a solid corner cube.

In another preferred embodiment, the present invention provides a service providing device being integrated with an active optical ID tag device wherein a light source is included to modulate and transmit ID and other service data to a service terminal device.

### BRIEF DESCRIPTION OF THE DRAWINGS

The above and other objects, advantages and features of the present invention will occur to those skilled in the art from the following description of the preferred embodiments and the accompanying drawings, in which:

FIG. 1A is a schematic diagram of a service providing system composed of a service providing device, a terminal device, an optical ID tag device housed in the service providing device, and a server device, according to an preferred embodiment of the present invention;

FIG. 1B is a schematic diagram of a service providing system composed of a service providing device, a terminal device, an optical ID tag device housed in the service providing device, and a server device, according to another preferred embodiment of the present invention by incorporating in RF wireless communication capability into the system;

FIG. 1C is a schematic block diagram of the service providing device in accordance with the preferred embodiment of FIG. 1A illustrating the function elements of the service providing device and the optical ID tag device;

FIG. 1D is a schematic block diagram of the terminal device and the server device in accordance with the preferred embodiment of FIG. 1A illustrating the function elements of the terminal device and the server device;

FIG. 2 is a schematic block diagram of a terminal device in optical communication with an optical ID tag device that is built by attaching a MEMS light modulator to a corner cube retro-reflector according to a preferred embodiment of the present invention;

FIG. 3A is a block diagram showing the primary optics components of a terminal device in accordance with the preferred embodiment of the present invention showing FIG. 2;

FIG. 3B is a block diagram showing the primary components of a terminal device incorporating a fiber coupled infrared laser source, a collimator, a beam splitter (or a beam shifter), a beam expander, and a photo detector (receiver) in accordance with the embodiment of the present invention showing in FIG. 2;

FIGS. 4A-C are magnified perspective views of three preferred embodiments of the MEMS modulating corner cube retro-reflector in accordance with the present invention as shown in FIG. 2;

FIG. 5A is a perspective view of the optical ID tag device with a MEMS light modulator according to the embodiment showing in FIG. 2 wherein the MEMS light modulator is a rotational rigid micro-mirror;

FIG. 5B is a perspective view of the optical ID tag device with a MEMS light modulator according to the embodiment showing in FIG. 2 wherein the MEMS light modulator is an array of rotational rigid micro-mirrors;

FIG. 5C is a perspective view of the optical ID tag device with a MEMS light modulator according to the embodiment showing in FIG. 2 wherein the MEMS light modulator is a deformable membrane micro-mirror;

FIG. 5D is a perspective view of the optical ID tag device with a MEMS light modulator according to the embodiment showing in FIG. 2 wherein the MEMS light modulator is an array of deformable membrane micro-mirrors;

FIGS. 6A-B are magnified views of the MEMS modulating corner cube retro-reflector composed of a plural of rotational rigid micro-mirror in an arrayed arrangement according to the preferred embodiment showing in FIG. 5B;

FIGS. 6C-D are a magnified views of the MEMS modulating corner cube retro-reflector composed of an array of deformable membrane micro-mirrors, functioning effectively as a diffractive grating according to the preferred embodiment showing in FIG. 5D;

FIG. 7A is a perspective views of an omni-directional corner cube embodiment comprising four MEMS modulating corner cube retro-reflectors arranged respectively on four quadrants of a support substrate;

FIG. 7B is a perspective view of a hollow corner cube retro-reflector being installed with three MEMS light modulators on three facets, respectively, each modulating light independently, capable of representing multiple or multiplexed data channels;

FIG. 8A is a schematic cross sectional view showing the primary components of the diffractive grating light modulator associated with the array of the deformable membrane micro-mirrors as shown in FIG. 5D embodiment of the present invention;

FIG. 8B is a schematic cross sectional view showing the primary components of the arrayed deformable membrane micro-mirrors being deflected under electrostatic actuation, functioning as a diffractive grating light modulator, in accordance with the FIG. 5D embodiment of the present invention;

FIGS. 9A-F are partial isometric cross-sectional views of the deformable membrane micro-mirrors at various stages of fabrication, according to one preferred fabrication process of the present invention.

### DETAILED DESCRIPTION OF THE INVENTION

To provide an overall understanding of the invention certain illustrative embodiments will now be described, including the server device, the service providing device, the optical ID tag device, and the terminal device. More particularly, the devices and methods described herein include, among other things the preferred embodiments of the service providing devices with the built-in optical ID tag device and the methods for making the same suitable for integration into the service providing device. Those skilled in the art will recognize that many alternative embodiments can be accomplished using the teachings of the present invention and that the systems and methods described herein may be adapted, modified, and employed for other suitable applications, and that such other additions and modifications will not depart from the scope hereof.

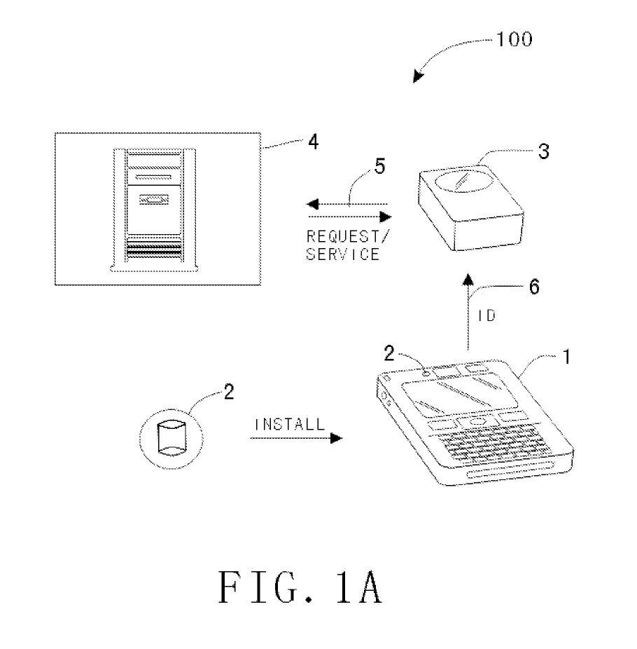

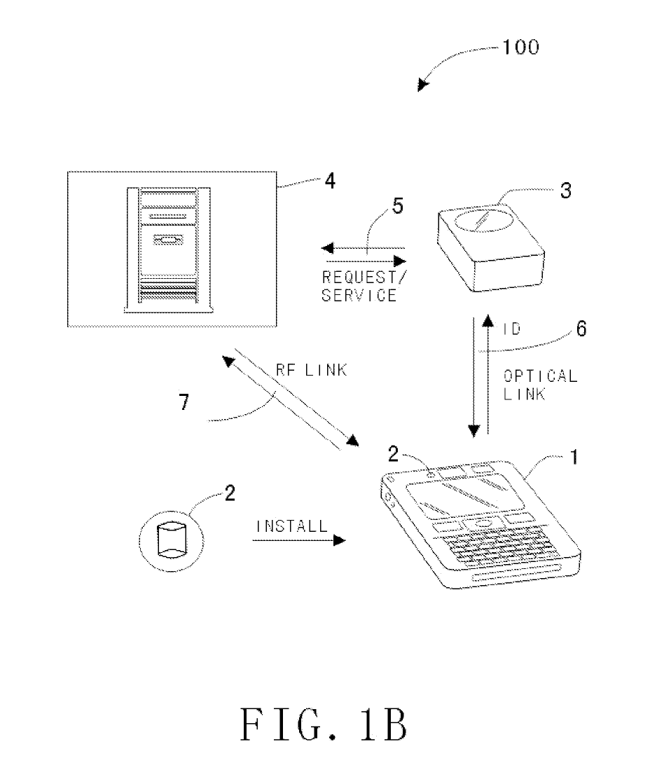

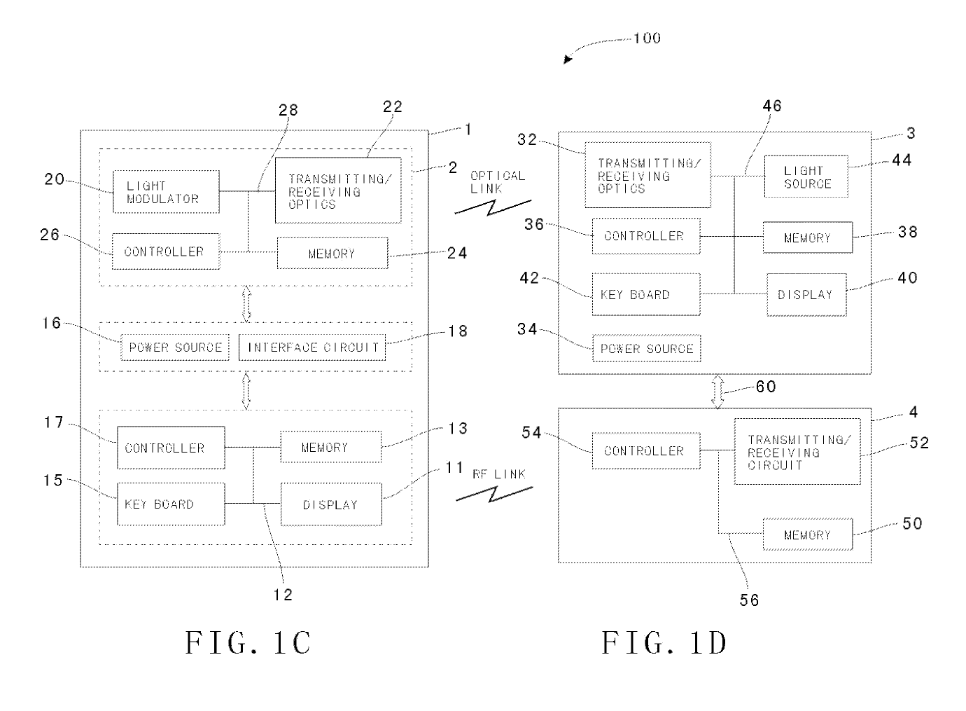

FIG. 1A is a conceptual schematic diagram of a service providing system 100 composed of a cell phone 1 as a service providing device, a terminal device 3 (as ID reader), an optical ID tag device 2 housed in the service providing device 1, and a server device 4, according to an preferred embodiment of the present invention. The service providing system 100 can alternatively be formed by incorporating an optical ID tag device into other forms of service providing device other than the cell phones such as smart phones, media players, portable digital assistants (PDAs), digital cameras, wristwatches, rings, keys and necklaces. The optical ID tag device 2 is incorporated in or attached to the cell phone 1 which provides a housing for the optical ID tag device 2. The cell phone 1 transmits/receives data to/from the terminal device 3 by using the optical communication link 6 that is enabled by the optical ID tag 2. The terminal device 3 transmits/receives data to/from the server device 4 through a network line 5. The terminal device 3 receives an ID of the optical ID tag 2 and relays the received ID to the server device 4 for authentication. The server device 4 authenticates the received ID and service request information, and generate a notification to allow or not allow the provision of the requested service, or provides information data contents to be sent to the terminal device 3, or relayed to the cell phone 1.

Alternatively, as shown in FIG. 1B, data generated by the server device 4 can be directly transmitted to the cell phone 1 by using a RF wireless communication channel such as a commercial mobile phone service. Alternatively, the cell phone 1 may use the RF communication channel 7 to directly transmit data to the server device 4 for confirmation of the transaction contents. Alternatively, the optical ID tag device 2 may be used as an optical receiver for receiving data from the terminal device 3.

Referring to FIG. 1C, a schematic block diagram of the service providing device in accordance with the preferred embodiment of FIG. 1A is used to illustrates the function elements of the service providing device that includes the enclosed optical ID tag device.

As shown in FIG. 1C, the cell phone 1 includes an optical ID tag device 2, a display 11, a memory 13 as a storage unit, a key board 15 as an input unit, and a controller 17 as a control unit. These components are connected through a control bus 12. The optical ID tag device 2 includes a light modulator 20 as a data-modulating unit, a transmitting/receiving optics 22 as a optical path control unit, a memory 24 as a storage unit, and a controller 26 as a control unit. Among them, the electronic components 24 and 26 and the electronic portions of components 20 and 26 are connected through a control bus 28. Under the control of the controller 26, the light modulator unit 20 reads information (ID and other information necessary for fulfilling the requested service) stored in the memory unit 24. Electrical signal data is transformed to optical signal data by the light modulator 20, and the optical signal is then transmitted to the terminal device 3 through the transmitting/receiving optics 22. The optical ID tag device 2 and other components of the cell phone 1 are supplied with electrical power through a shared power source 16 which may be a built-in battery unit or an external power supply. The optical ID tag device 2 and other components of the cell phone 1 are capable of interfacing through an interface circuit 18. Under the control of the interface circuit 18, the controller unit 17 of the cell phone 1 and the controller unit 24 of the optical ID tag 2 are able to exchange instructions. As a result, the user interfaces of the cell phone 1 (i.e. the display 11 and the key board 15) enable users to control the progress for the requested service and confirm the data contents of the provided service thereafter.

Referring to FIG. 1D, the server device 4 may include a memory unit 50 as data storage unit, and a transmitting/receiving circuit 52, a controller 54 as control unit, and a control bus 56 for connecting these elements. The server device 4 fulfills the communication with the terminal device 3 through the service network line 60. Optionally, the server device 4 communicates with the cell phone 1 through a RF communication channel.

The terminal device 3 includes a transmitting/receiving optics 32 to enable data acquisition from the transmitting/receiving optics 22 of the optical ID tag device 2, as shown in FIG. 1D. The terminal device 3 includes a power source 34, a controller 36 as a control unit, a memory 38 as a storage unit, and optionally, a display unit 40 and a key board unit 42 as user interfaces, and a light source 44 for either actively sending data to the optical ID tag device 2 or passively interrogating data from the optical ID tag device 2. Among them, the electronic components 34, 36, 38, 40, 42, and the electronic portions of the components 44 and 32 are connected through a control bus 46. Under the control of the controller 46, the transmitting/receiving optics 32 reads ID and other data from the optical ID tag device 2.

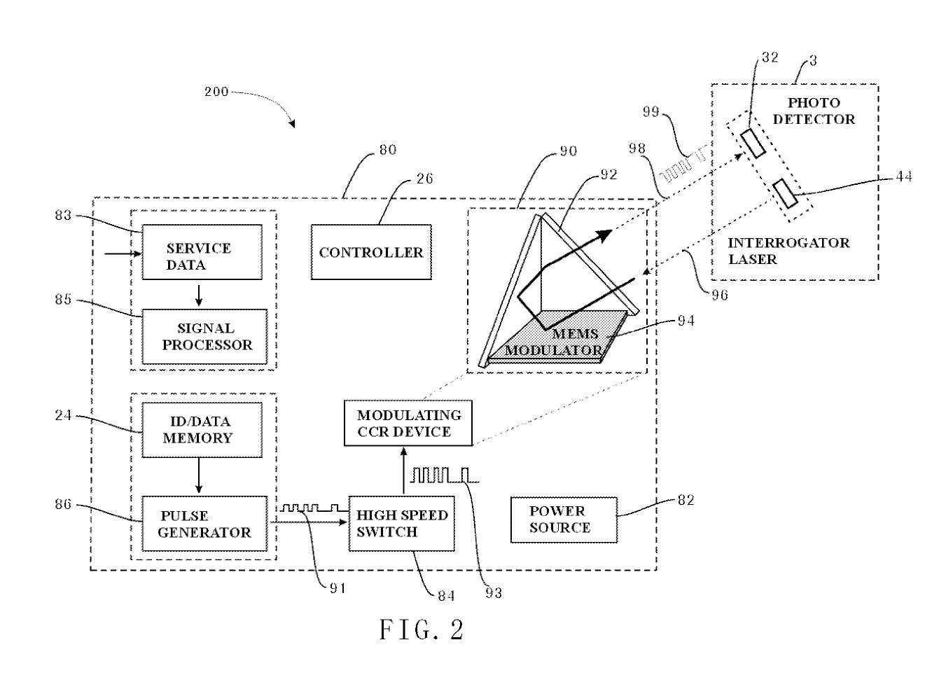

When light source 44 is present, a highly preferred embodiment will be to use the light source 44 for data interrogating. An optical communication link can be established between the terminal device 3 and the optical ID tag device 2 in an optically passive manner. The term “optical passive” used herein is understood as such that no light source is required to install in the service providing device (i.e. the cell phone 1. Therefore, under this passive communication circumstance, the optical ID tag device 2 is utilized as an optical passive transmitter 80 wherein no light source is necessarily required but instead a light modulating retro-reflector device 90 is incorporated in the optical ID tag device for data modulating. The modulated data is then loaded onto the retro-reflected beam, returning to the terminal device 3, as shown in FIG. 2.

Referring to FIG. 2, the optical ID tag device 2 is now designated as a passive optical transmitter 80 comprising of a memory unit 24 as data storage unit, a controller 26 as control unit, a power source 82, a high speed switch circuit 84, a data pulse generator 86, and a MEMS modulating corner cube retro-reflector device 90 according to a preferred embodiment of the present invention. In the preferred embodiments, data can be stored either in the memory unit 24 or externally input through a service data interface 83 and a signal processor 85. Data can be digitized to feed the high speed switch circuit 84 through the pulse generator 86. The power source 82 converts the power supply of the cell phone 1 to a preset DC voltage level (e.g. optical extinction voltage for the light modulator), the data pulse generator 86 feeds the data pulse train signals (from the memory 24 or from the signal processor unit 85) for controlling the high speed switch circuit 84, and the switch circuit 84 then hammers the DC voltage and outputs the pulsed preset voltage signals to the MEMS modulating corner cube retro-reflector device 90. Alternatively, the power source 82 can be designed to convert the power supply provided by the cell phone 1 to a preset current level. The MEMS modulating corner cube retro-reflector device 90 is formed by attaching a MEMS light modulator 94 with a corner cube retro-reflector component 92. The MEMS light modulator 94 may be attached to one inner facet of a hollow corner cube, or to one back facet of a solid corner cube.

FIG. 2 schematically shows an optical link system 200 established between a terminal device 3 and a MEMS-modulated optical ID tag 80 that is formed by attaching a MEMS light modulator 94 with a corner cube retro-reflector component 92 according to the preferred embodiment of the present invention.

Referring to FIG. 2, the terminal device 3 herein is schematically simplified to show two function elements: the light source 44 (i.e. the interrogating laser) and the transmitting/receiving optics 32. In optical operation, the interrogating laser (i.e. the light source 44) sends interrogating light beam 96 to the passive optical transmitter 80, the MEMS modulating corner cube retro-reflector 90 retro-reflects the incident light beam 96 back to the terminal device 3. The retro-reflected light beam 98 is directed to the transmitting/receiving optics 32. Electrically, data is provided to the MEMS light modulator 94 through the pulse generator 86 and the switch circuit 84. The data sequence 91 is first expressed as pulsed train signals 93 at a preset voltage level. The pulsed train signals 93 actuate the mechanical motion of the MEMS light modulator 94 to modulate the retro-reflected light intensity of the incident light beam 96. The electrical data signal is represented as the modulated data 99 carried by the retro-reflected light beam 98. As such, an optical link is established between the terminal device 3 and the optical ID tag 2. The link physically is composed of two types of light beams: the incident light beam 96 serving for data interrogating, the retro-reflected light beam 98 serving as a data carrier.

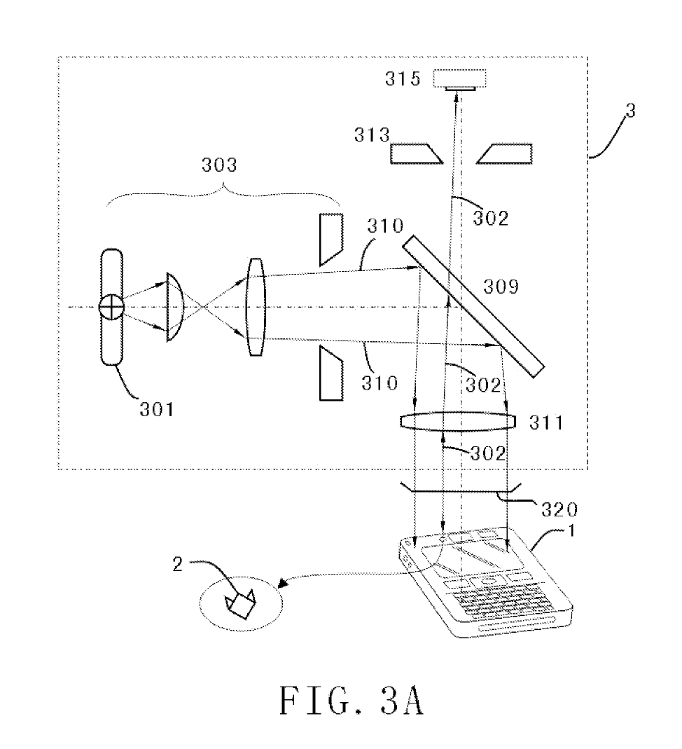

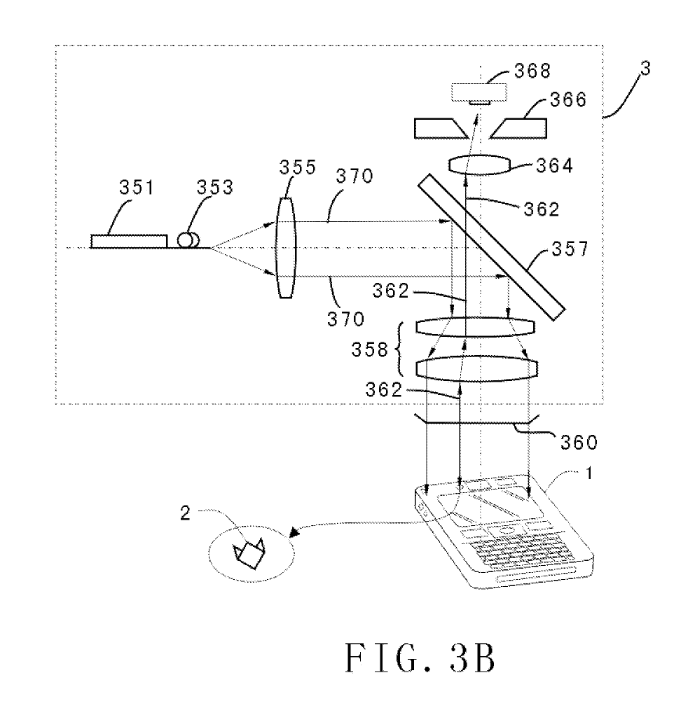

Referring to FIG. 3A and FIG. 3B, the optical link system 200 showing in FIG. 2 is described with more details in optics.

FIG. 3A is a block diagram showing the primary optics components of an optical interrogator terminal 3 in accordance with a preferred embodiment of the present invention. The primary optics of the interrogating terminal 3 includes a light source 301, an illumination assembly 303, a beam splitter 309, a collimating lens 311, a spatial filter 313, and a light detector 315. The light source 301 can be either broadband (e.g. commercial white light sources) or narrowband (e.g. lasers). The illumination assembly 303 is used to adjust the size and collimation of the light beam 310, and to direct the light beam 310 onto a beam splitter 309. The beam splitter 309 directs a portion of the light beam 310 onto a collimation lens 311. The collimation lens 311 directs a light beam 320 out of the interrogating terminal 3, serving as the incident beam to interrogate the service providing device 1. A portion of the light beam 320, —the light beam 302, i.e. the light portion incident onto the region where the optical ID tag device 2 is located, is retro-reflected. This portion of light then transmits through the beam splitter 311, through the spatial filter 313, to reach a light detector 315 to be detected into electrical data signals. The presence of the corner cube retro-reflector ensures certain portion of the incident beam be retro-reflected according to the relative angular positions of the optical ID tag device with respect to the interrogating light beam. As the light modulator is capable of transmitting data at much higher bit rate than the possible shaking or waving frequency of a human hand, the ID and other service information can be reliably delivered to the terminal device without disturbance. The communication is non-broadcasting because (1) a tiny portion of the interrogating light beam is effectively in use for data communication, and (2) the retro-reflected light portion can be restricted to return to the output window of the terminal device.

Now referring to FIG. 3B, a block diagram showing the primary optics of a terminal device 3 incorporating a fiber coupled infrared laser source 351, fiber link 353, a collimator 355, a beam splitter 357, a beam expander assembly 358, a focusing lens 364, a spatial filter 366, and a light detector 368 in accordance with another illustrative embodiment of the present invention. The collimator 355 directs the light beam 370 onto a beam splitter 357. Beam splitter 357 directs the light beam 370 to a beam collimation and expanding assembly 358. Beam collimation and expanding assembly 358 directs the light beam 360 out of the terminal device 3 to the service providing device. A portion of the light beam 360, i.e. the light beam 362, as shown in FIG. 3B, is retro-reflected by the optical ID tag device 2, transmitted through the beam splitter 357, the focusing lens 364, and the spatial filter 366, finally reaches the a light detector 368.

In summary, as shown in FIG. 3A and FIG. 3B, the optical ID tag device 2 resides in the cell phone 1, functioning to retro-reflect a portion of the incident interrogating light beam. As at least one facet of the corner cube is attached with a light modulator, the portion being retro-reflected becomes capable of carrying modulated data. As such, non-broadcasting optical wireless communication is achieved.

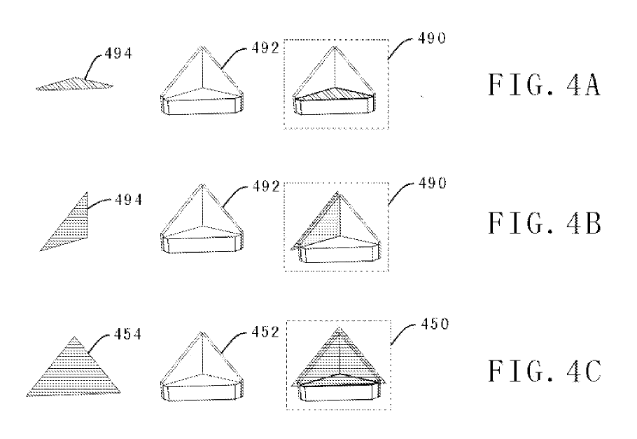

To attach a light modulator to a corner cube retro-reflector, there exists in general three configurations as follows: (1) attaching the light modulator to in inner facet of a hollow corner cube, (2) attaching the light modulator to an back facet of a solid corner cub, and (3) attaching the light modulator in front of the three facets of a corner cube, as shown in FIG. 4A, FIG. 4B, and FIG. 4C, respectively.

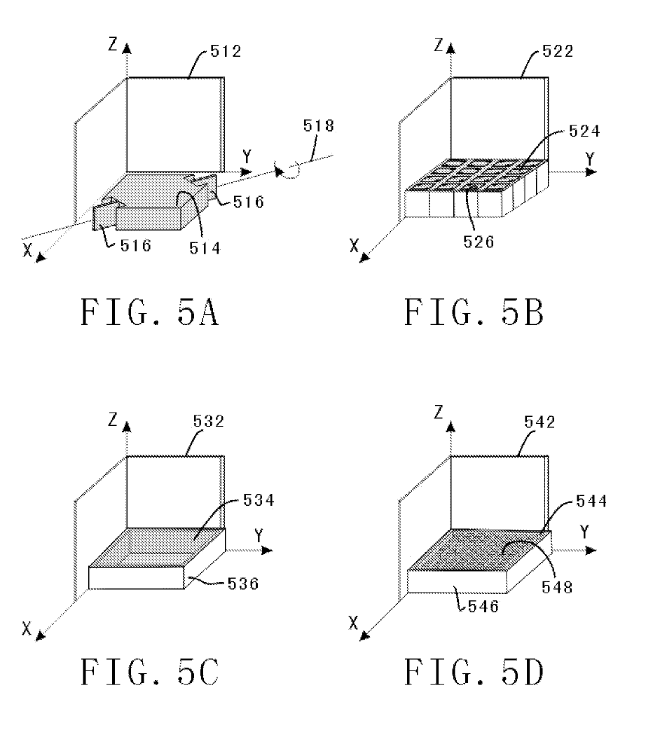

Referring now to the FIGS. 4A-C, the three basic configurations are illustrated for attaching a light modulator 494 to a corner cube retro-reflector 492 in order to build a modulating corner cube retro-reflector 490. In FIG. 4A the light modulator 494 is attached to one inner facet of a hollow corner cube 492. In FIG. 4B the light modulator 494 is attached to one back facet of a solid hollow corner cube 492. In both configurations, the light modulator 494 can optionally be attached to any of the three facets of the corner cube 492. In both configurations, the light modulator 494 is preferred to be a MEMS light modulator wherein light modulation is usually achieved by moving a micron-sized tiny mechanical mirror part. However, in FIG. 4C a light modulator 454 is placed in front of the three facets of a corner cube 452 by which the light modulator 454 is used in transmission mode to modulate light. The preferred light modulator for use in the FIG. 4C configuration is liquid crystal light modulator, multi quantum well light modulator, phase conjugate light modulator, or electro-optic crystal based light modulator. In enabling a modulating corner cube retro-reflector, these refractive light modulators are disadvantageous in their angular sensitivity because the optical path in the propagation media has angular dependence. In contrast, MEMS light modulators are preferred to be used in reflective mode. Shown in FIG. 5A, FIG. 5B, FIG. 5C and FIG. 5D are four typical types of MEMS light modulators in attachment with a hollow corner cube, respectively.

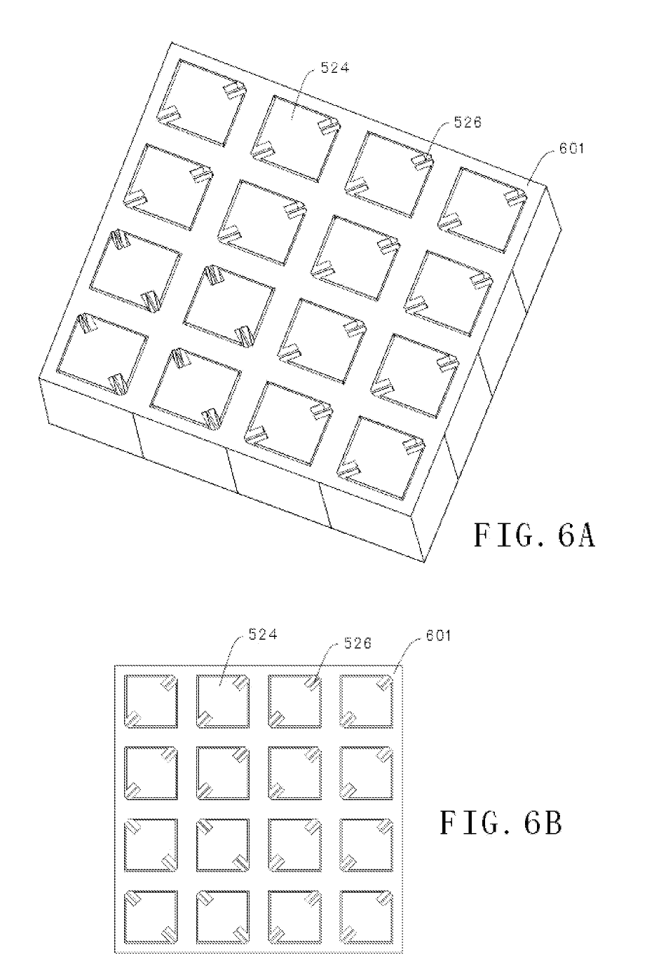

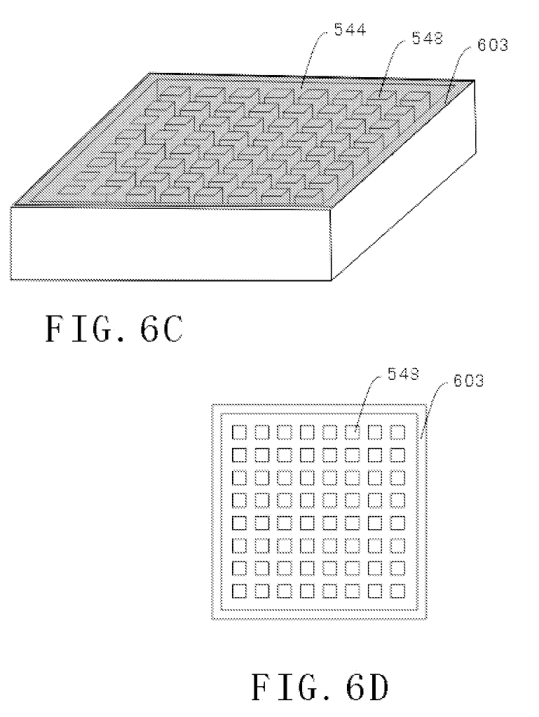

FIG. 5A shows a perspective view of a MEMS light modulating corner cube retro-reflector according to the preferred embodiment of the present invention showing in FIG. 2. Herein the MEMS light modulator is a rotational rigid micro-mirror 514 installed to one facet (X-Y plane) of a hollow corner cube retro-reflector 512. The tilting mirror 514 is suspended by a set of torsional springs 516, capable of rotate around the axis 518 under an actuation force. The actuation force can be generated by electrostatic, electromagnetism, thermal, and piezoelectric mechanisms, etc. FIG. 5B shows a perspective view of a MEMS light modulating corner cube retro-reflector according to the preferred embodiment of the present invention showing in FIG. 2. Herein the MEMS light modulator is a 4×4 array of rotational rigid micro-mirrors 524 installed onto one facet (X-Y plane) of a hollow corner cube retro-reflector 522. Similar to the mirror 514 in the FIG. 5A, each of the mirrors in the array 524 is also suspended by a set of springs 526, thus capable of rotation under actuated conditions. FIG. 6A shows a magnified view of the MEMS light modulator comprising of a 4×4 array of the micro-mirrors 524 suspended by springs 526 in the fixed frame of 601 according to the embodiment showing in FIG. 5B. According, FIG. 6B shows the magnified top view of the micro-mirror array 524.

Alternatively, the MEMS light modulator, as used in the preferred embodiment of the present invention showing in FIG. 2, may also be constructed of flexible membrane whose deformation alters the retro-reflected intensity of an incident light. Shown in FIG. 5C is a perspective view of this type of MEMS modulating corner cube retro-reflector according to the preferred embodiment wherein the MEMS light modulator includes a deformable membrane 534 and a frame 536. The edge portion of membrane 534 is disposed onto the frame 536. The light modulator is installed to one facet (X-Y plane) of the hollow corner cube retro-reflector 532.

Alternatively, the MEMS light modulator, as used in the preferred embodiment of the present invention showing in FIG. 2, can also be constructed of an array of membrane micro-mirrors. FIG. 5D is a perspective view of this type of MEMS light modulator built on a support substrate 546 illustrating the array of deformable membrane micro-mirrors is formed by stretching a flexible membrane 544 over an array of posts 548, thus dividing the membrane 544 into a plural of small deformable membrane micro-mirrors. In optics, the array of the micro-mirrors functions as a reflecting diffractive grating capable of diffracting an incident light beam into multiple far field orders of light beams following the principle of diffractive optics. FIG. 6C shows a magnified view of the MEMS light modulator. Accordingly, FIG. 6D is the magnified top view of the posts 548, illustrating the way the deformable membrane 544 is divided into multiple membrane micro-mirrors.

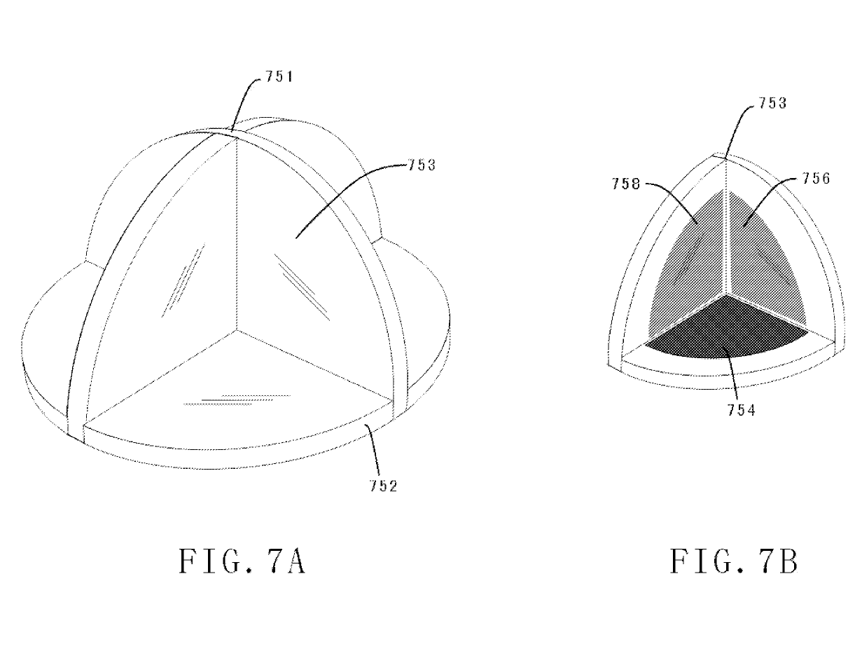

Referring to FIG. 7A, a perspective view of an omni-directional corner cube embodiment 751 comprising four MEMS-modulating corner cube retro-reflectors 753 arranged on four quadrants of a common support substrate plate 752, is used to illustrate an preferred embodiment of an optical ID tag device 2. In theory, such an optical ID tag device is capable of building optical communications with interrogating lights incident from all directions from above the plane of the support substrate 752. FIG. 7B further shows one quadrant portion 753 of the preferred corner cube embodiment 751 in attachment with three MEMS light modulators 754, 756, and 758 on each of three facets, respectively, each representing an independent optical communication channel, providing an increased bandwidth for the service providing device 1. Each of the three MEMS light modulators may operate at different frequency or data rate, and the three channels can be configured to operate in time sequence or in a multiplexed manner.

In a preferred embodiment of the present invention, the three communication channels enabled in each of the four quadrants of the omni-directional corner cube retro-reflector 751 can be designed to modulate and transmit data in a time sequential manner and operate to code data in varied bit rates. Thus, each channel is capable of representing one unique ID and communication channel. These unique IDs with channels may be used for different type of identities for communication of various application or service data. For example, in one preferred embodiment, the omni-directional modulating retro-reflector, when in attachment with a service providing device, can be used to determine the relative position and angular positions of the device with respect to an interrogating terminal.

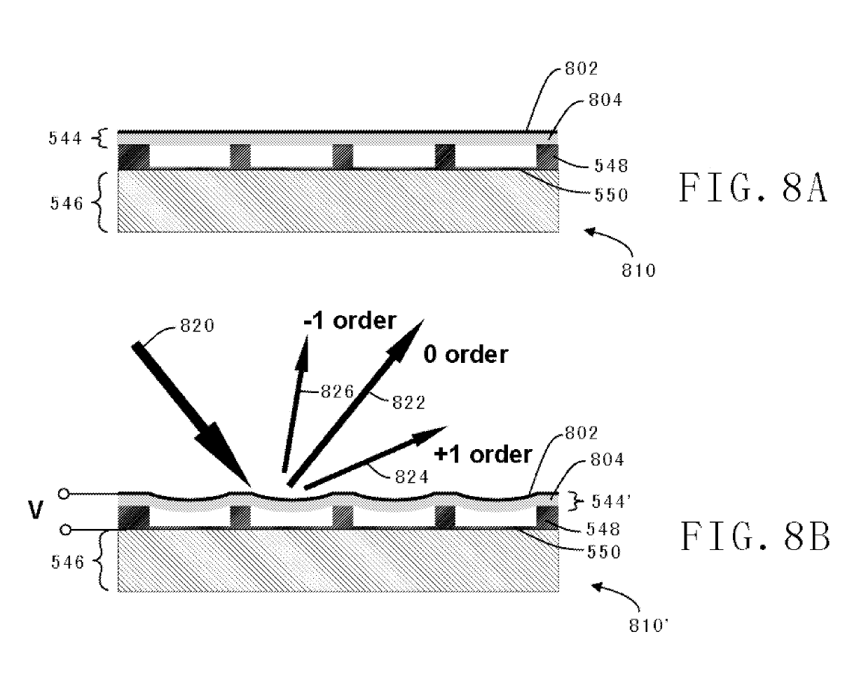

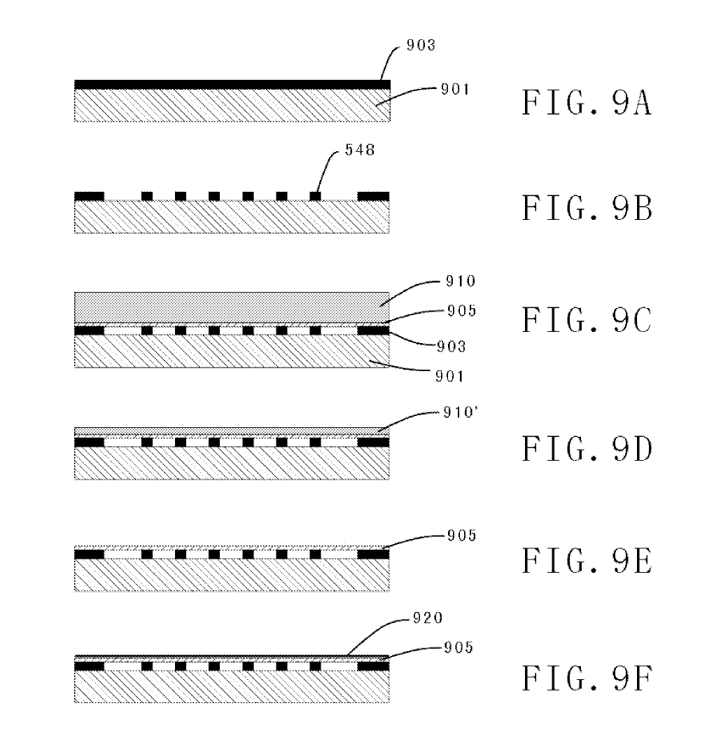

Referring to FIG. 8A, a schematic cross sectional view of a diffractive light modulator 810 shows the layered components 544, 546, and 548 of the diffractive light modulator 810 associated with the FIG. 5D embodiment of the present invention. The membrane 544 herein is a composite membrane comprising a supporting layer 804 and a reflective layer 802. Either of the two layers can be electrical conductive and the supporting substrate 546 has a pre-deposited electrode layer 550. The two electrodes may form an electrostatic capacitor device. When actuated at a voltage V the membrane 544 will deform to show surface depth distribution, which effectively in optics is a diffractive grating light modulator 810. The surface depth distribution relies on the shape geometry, dimensions and the arrayed distribution of the posts 548. The preferred post shape designs in accordance with the present invention are square, rectangular bar, triangle, circle and hexagon. The preferred post shape designs also include those curved features by modifying the above fundamental shapes. Another important design consideration for the posts 548 is the arrayed distribution manner. In real practice, the preferred post distributions include linear or line (for long bar posts) distribution, triangular, square and hexagonal distributions.

Referring now to FIG. 8B, a schematic cross sectional view of an actuated diffractive light modulator 810′ is shown to illustrate the deformed membrane 544′ under electrostatic voltage V. An incident light beam 820 is reflectively diffracted at the surface of the membrane 544′, generating not only the zero order diffractive beam 822 but also multiple higher order diffractive beams at varied angles. Shown in FIG. 8B are the zero order diffractive beam 822, a +1 order diffractive beam 824 and a −1 order diffractive beam 826. As the zero order diffractive beam 822 has the same direction as that of a normal reflected beam, the beam is used as the retro-reflected signal.

Manufacturing a suspended deformable membrane, however, is usually troublesome and controlling such a membrane for quality optical surface (e.g. flatness and roughness), thickness uniformity, and for repeatability in the actuated deflection, is also problematic. There are in general three basic types of methods for fabricating a suspended membrane onto a micromachined semiconductor substrate: direct membrane disposing method, wafer-level membrane transfer method, and the method of using sacrificial materials, each has its unique advantages and disadvantages. Shown in FIGS. 9A-F are partial isometric cross-sectional views of a deformable membrane diffractive grating at various stages of fabrication, according to one preferred embodiment of the present invention showing in FIG. 5D and FIG. 8B, wherein the disclosed fabrication process flow is a improved wafer-level membrane transfer process that is preferred to be used in producing high quality MEMS membrane light modulators.

Shown in FIG. 9A is a semiconductor substrate 901 coated with a spacer material layer 903. In FIG. 8B, the posts 548 are produced on the substrate 901 by using micromachining techniques. A wafer-level bonding technique is then used to merge the spacer layer 903 of the first substrate 901 with a first membrane material layer 905 of a second a substrate 910, as shown in FIG. 9C, followed by a wafer thickness reducing process showing in FIG. 9D.

As shown in FIG. 9D, a wafer thickness reducing process is applied to the bonded wafer pair to reduce the thickness of the second substrate 910. In a preferred embodiment, the second substrate 910 is silicon material, and the thickness reducing methods are preferred to be grinding, lapping, and/or polishing methods. Wet chemical etching may not recommended at this step because of the technical concerns on thickness uniformity, surface roughness, and generating of pits and waviness on the surface. After grinding, lapping and/or polishing operation, the target substrate 910 could be reduced to a thickness less than 100 microns, sufficient thin now for a time-saving chemical etching for removal of the silicon layer in full.

As shown in FIG. 9E, a chemical wet etching process, a dry etching process, or a reactive ion etching process, may be applied to remove the left-over thickness of the substrate 910 in full, exposing the suspended membrane 905. The entire fabrication for deformable membrane may be concluded with a reflective material coating process to add an optical reflective layer 920 as shown in FIG. 9F.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

1. A service providing system, comprising:
a terminal device capable of transmitting/receiving data to/from a service providing device by optical communication;
a service providing device that transmits/receives data to/from the terminal by optical communication; and
a server device that processes the data and request information received from the terminal device.

2. The service providing system of claim 1, wherein the service providing device comprises an optical ID tag device.

3. The service providing device of claim 2, wherein the optical ID tag device comprises a means of modulating optical data signals.

4. The optical ID tag device of claim 3, wherein the means of modulating optical data signals is an active means by using a local light source in the optical ID tag device.

5. The optical ID tag device of claim 3, wherein the means of modulating optical data signals is a passive means by using an interrogating light source in the terminal device.

6. The optical ID tag device of claim 5 wherein comprises a modulating corner cube retro-reflector and wherein the modulating corner cube retro-reflector is built by attaching a light modulator to the corner cube retro-reflector.

7. The optical ID tag device of claim 6 wherein the light modulator is a Micro-Electro-Mechanical Systems (MEMS) light modulator.

8. The modulating corner cube retro-reflector of claim 7, wherein the MEMS light modulator comprises a rotational rigid micro-mirror.

9. The modulating corner cube retro-reflector of claim 7, wherein the MEMS light modulator comprises an array of rotational rigid micro-mirrors.

10. The modulating corner cube retro-reflector of claim 7, wherein the MEMS light modulator comprises a deformable membrane micro-mirror.

11. The modulating corner cube retro-reflector of claim 7, wherein the MEMS light modulator comprises an array of deformable membrane micro-mirrors, and wherein the array of deformable membrane micro-mirrors works as diffractive grating to modulate light.

12. The modulating corner cube retro-reflector of claim 7, wherein the MEMS light modulator comprises of lateral-actuated optical shutter.

13. The optical ID tag device of claim 6, wherein the light modulator is a refractive light modulator including multi quantum well light modulator, phase conjugate light modulator, liquid crystal light modulator, or electro-optic ceramic light modulator.

14. The optical ID tag device of claim 6, wherein the corner cube retro-reflector comprises multiple quadrant corner cubes in attachment with multiple light modulators.

15. The optical ID tag device of claim 6, wherein multiple light modulators are attached to facets of one quadrant corner cube, each capable of representing an independent optical signal channel.

16. The optical ID tag device of claim 14, wherein the multiple optical signal channels are used to transmit data in a time sequence configuration.

17. The optical ID tag device of claim 14, wherein the multiple optical signal channels are multiplexed to transmit data.

18. The optical ID tag device of claim 14, wherein the multiple optical signal channels are used to transmit data about the relative position and orientation of the service providing device with respect to the terminal device of claim 1.
